(19) United States
(12) Patent Application Publication
(10) Pub. No.: US 2018/0209204 A1
(43) Pub. Date: Jul. 26, 2018

(54) Tandem Windows for High Energy Efficiency

(71) Applicant: Donald Robert Wulfinghoff, Wheaton, MD (US)

(72) Inventor: Donald Robert Wulfinghoff, Wheaton, MD (US)

(21) Appl. No.: 15/414,571

(22) Filed: Jan. 24, 2017

(51) Int. Cl. E06B 1/36; E06B 3/44; E06B 7/10; E06B 3/66

(52) U.S. Cl. CPC E06B 1/36; E06B 3/66; E06B 7/10; E06B 3/4415

(57) ABSTRACT

A configuration of tandem high efficiency primary windows is disclosed as both a structure and method to enhance the energy efficiency of windows. Each of the tandem windows is separately installed, respectively, on the exterior and interior of a building window opening. Each window may be separately operable for opening, closing, and cleaning. The interior window can include a cover, surrounding any part of the frame that protrudes into the interior space, the cover having an air gap for interior air to circulate and remove moisture from the interior surfaces of the interior window and its frame. The space between the windows is vented for removal of water vapor, if necessary, by a tube that extends from the space to the outside or to the cold side of the window opening, the tube having features that prevent the entry of outside into the space between the windows.

### CROSS-REFERENCE TO RELATED APPLICATIONS

This application claims the benefit of prior filed U.S. Provisional Application Ser. No. 62/287,851, filed Jan. 27, 2016.

### FEDERALLY SPONSORED RESEARCH

Not applicable.

### SEQUENCE LISTING OR PROGRAM

Not applicable.

### BACKGROUND

### Field of Endeavor

This application relates to windows used in buildings and other enclosures, and specifically to improving the energy efficiency and convenience of windows by improvements to the configuration of window frames and related moisture venting to make it practical and convenient to install multiple high-efficiency windows in tandem in individual window openings.

### BACKGROUND

### Prior Art

### Limitations on the Number of Panes in a Window Assembly

In buildings and in other enclosures where it is desired to maintain a temperature difference between inside and outside, windows typically are the greatest source of heat loss. This is well recognized, and many improvements to windows to reduce their heat loss have been developed or proposed.

In the prior art, it is recognized that the panes of glazing provide most of the insulation value of a window, primarily by virtue of the insulating air or gas layers that attach to the surfaces of each pane. Therefore, various methods of increasing the number of panes have been implemented. However, there are limitations to these methods:
In windows with glass panes, the weight of the glass comprises most of the weight of the window assembly. In order to make the weight of a window manageable for handling and installation, the number of glass panes is commonly limited to two, especially for windows that are openable. In fixed windows, triple panes are sometimes used.
The interstitial spaces between the panes in a multi-pane window assembly must be sealed hermetically in order to prevent fogging and staining of the surfaces facing into the interstitial spaces. Unfortunately, the seals that are used around the edges of the panes to enclose the interstitial spaces are subject to failure. The reliability and the service life of the seals is reduced, and the difficulty of manufacture is increased, if more than two panes are used in the window assembly.
Lightweight plastic films may be used as additional panes in order to reduce the weight penalty. These films are fragile, so they are installed between outer panes of glass. These increase the complexity of the glazing edge seals. And, the plastic material is vulnerable to destruction by sunlight, limiting the life of the window.

Gases other than air can also provide thermal resistance in windows. In the prior art, gases that have R-values higher than the R-value of air are used optionally within multi-pane windows. However, in the prior art, such gases tend to leak out of the windows at the seals between panes, and the gases are gradually replaced by air and water vapor from the surrounding space.

### Frame Configuration for Window Installation

In prior art, there are two prevalent methods of installing windows in window openings. The older method is for the window to have a frame that fits within the window opening, and for the frame to be secured by strips of wood or other material (commonly called “stops”) that are fastened to the structure of the opening. With this method, the window may be located anywhere within the window opening. Typically, but not necessarily, the window is located near the outer side of the wall opening. The installation typically includes an exterior sill to shed rain toward the outside. The sill may be integral with the frame, or a separate sill may be installed.

The newer method of window installation is the incorporation of integral flanges to surround the frame, and to attach the flanges to the external wall surface with nails or screws. The newer method makes the window easy to install, it has the potential of eliminating air leakage between the frame and the window opening, and it does not require a sill to shed rain.

The position of the window within the wall opening is determined by the location of the flanges on the frame.

In prior art, manufacturers of flanged windows assume that windows will be mounted on the exterior wall surfaces surrounding the window opening. In this way, the flanges provide effective shedding of rain. Typically, the flanges are located on the frame so as to provide protrusion of the frame beyond the outer wall surface so that siding material can be installed around the window.

The latches and locks for openable sashes are installed in the window assembly assuming this geometry.

### Supplemental Windows

In the prior art, various methods of increasing the thermal performance of windows have employed supplemental glazing to augment primary windows, commonly on a retrofit basis. (Such supplemental glazing is commonly called a “storm window.”) In prior art, such supplemental glazing is designed primarily for low cost. Such supplemental glazing has major deficiencies, including:
limited thermal effectiveness. The supplemental glazing typically consists of a single pane. As a result, it lacks the thermal improvements that are possible with multi-pane windows.
air leakage. If the supplemental glazing is removable to allow the windows to be opened, typically a large amount of air leakage can occur around removable glazing. If the supplemental glazing is designed to be openable without being removed, the manufacture and the method of opening typically allows a large amount of leakage around the movable pane or sash.
inconvenience. Where it is desired to open the windows by removing the supplemental glazing, it is necessary to physically remove the glazing and to have a place to store it. Supplemental glazing that is openable typically is difficult to manipulate or to keep in position.
limited service life. The lightweight and inexpensive construction of supplemental glazing results in a service life that is shorter than the service life of the primary window.
primitive condensation protection. If supplemental glazing has provision for venting to prevent condensation on the inner surface of the pane, the venting typically consists of small holes that are located in the frame. Such simple vents admit a certain amount of outside air to enter into the space between the primary window and the supplemental glazing, sacrificing thermal efficiency.

In prior art, primary high-efficiency windows have not been used as supplemental glazing. I.e., supplemental glazing has generally been limited to using a lightweight storm window in combination with a primary high-efficiency or multiple-glazed window.

This is primarily because the frame design of contemporary high-efficiency windows is unsuitable for installation of such windows in pairs, and such windows are also unsuitable individually for installation to supplement a previously installed window. Installing a contemporary flanged window on the interior wall surface of the window opening would be unsuitable because it would result in significant protrusion of sharp and unattractive structure of the window into the interior of the space.

Also, if tandem windows are to be openable for ventilation or for other purposes, the windows should be separated by a distance that provides convenient operation of the latches and locks of both windows, and that provides access for cleaning the surfaces of the windows in the interstitial space between the two windows. With walls of typical thickness, achieving such a separation commonly would not be possible by using a tandem pair of contemporary high-efficiency windows.

### Anti-Condensation Vents

During cold weather, the outer window of a tandem pair is colder than the inner window. Therefore, there is a tendency for water vapor to condense on the inner surface of the outer window. If this occurs, visibility through the window will be obscured by the condensed water or ice. Also, condensation causes damage to the structure of the window opening and it promotes the growth of mildew.

The causes of condensation on windows, and within multi-pane windows, are well known. When a combination of inner and outer windows are installed, as with a typical “storm window” installation, condensation generally results from leakage of moist air from the warm side of the window assembly around the frame and through the movable components of openable windows.

The prevalent solution to this problem is venting of the space between glazing elements to the cold side of the window assembly. Typically for supplemental glazing, such as storm windows, one or more small holes may be created near the bottom of the frame to act as a moisture vent.

The location of the vent is generally at or near the bottom of the frame of the window on the cold side. The reason for this location is that the temperature of the air in the space between the windows stratifies, with the colder air at the bottom of the space. Colder outside air that enters the interstitial space during cold weather tends to stratify at the bottom of the space, rather than mixing with the warmer air above.

A weakness of such simple vents is that they provide a path for entry of air from the outside into the interstitial space, bypassing the insulating value of the outer window. Such exchange of air occurs as a result of thermal expansion and contraction of the air within the interstitial space. In addition, wind pressure on the outside of the window may force outside air into the interstitial space through the vent.

Also, such vents are not designed to correspond to the air leakage rate of the primary window. They may be too small to vent all the moisture that leaks into the space between the primary window and the supplemental glazing. Or, they may be unnecessarily large, allowing an unnecessarily large amount of outside air to leak through the vents into the space between the primary window and the supplemental glazing.

Various prior patents offer methods of improving such venting, or of exploiting vent paths for ventilation of the space served by the window assembly. Such patents often are complex, requiring specialized manufacturing methods for the windows.

### Condensation on the Inner Surfaces of Window Frames

Generally, the frame of each window allows more thermal conduction than the glazed portions of the windows. This is because the frame provides a continuous path of solid material that allows heat to flow directly from the warmer side of the frame to the cooler side.

As a result, during cold weather, the inner surface of the frame of the inner window may have a temperature that is significantly lower than the interior space temperature. If the concentration of water vapor in the indoor air is sufficiently high, this may result in condensation of moisture on portions of the window frame that are exposed to the indoor atmosphere.

Such condensation, if it occurs, generally is transient, provided that the interior surface of the frame is open to warming by the interior air and is open to allow rapid evaporation of any condensation that forms.

### SUMMARY OF THE INVENTION

The object of the invention is to substantially improve the energy efficiency of windows by making it practical and convenient to install windows in tandem pairs in window openings, each window of the pair being able to incorporate the efficiency features and conveniences of contemporary window technology.

In the prior art, the installation of efficient windows in tandem pairs was prevented by the design of their window frames. The primary limitation has been the lack of a frame design that permits two efficient windows to be installed in the same window opening, especially if the windows are to be openable for ventilation or for other purposes.

My invention comprises several improvements to window frames that make it practical and convenient to install high-efficiency windows in tandem pairs, thereby more than doubling the thermal resistance of the window installation.

Each window of the tandem pair may be selected or configured individually, each window using any available technology to improve energy efficiency, durability, or other desirable characteristics.

Where openable windows are desired, the frame configuration increases the separation between the inner and outer windows to allow easy opening and closing of the windows from the interior space, to allow easy access to the locking features of the windows from the interior space, and to provide access for cleaning of the surfaces within the space between the windows.

In prevalent applications, such as windows in buildings, the increase in separation between the tandem pair of windows is achieved primarily by adapting the frame of the inner window so that it can be attached to the inner wall surfaces of the window opening in a manner that extends the inner window inward, thereby increasing the space between the inner and outer windows.

My invention includes the option to add a cover for the inward protruding portion of the inner window for the sake of appearance, to avoid dangerous impact on the protruding portion of the frame, for attaching desired window treatments, or for other functions. The cover allows circulation of interior air between the cover, the frame, and adjacent wall surfaces to avoid or minimize condensation on the window frame.

My invention includes the option to improve the moisture venting of the interstitial space between the inner and outer windows in a manner that minimizes the leakage of cold air into the interstitial space.

The pair of windows may be installed together, or an inner or outer window may be installed on a retrofit basis to form a compatible pair.

My invention is durable, easy to manufacture using conventional window manufacturing methods, easy to install, and easy to use.

My invention may include additional features that achieve other desirable effects.

### GLOSSARY

The following glossary is provided to aid in understanding the issues, theory, and equipment of the subject area of this invention:
frame. The outer structure of a window that holds the components of the window and that provides for attachment of the window to the building or other enclosed space. Or, the outer structure of a sash that holds the components of the sash.
glazing. Any material in windows that is used to transmit light. The material may be glass, plastic, oiled paper, or other transparent or translucent material.
interstitial space. In the context of this patent application, the space between adjacent window surfaces, which may be the space between the panes in a multi-pane window, or the space between the facing sides of the inner and outer windows of a tandem pair.
interstitial surface. In this patent application, a surface of a pane or frame that lies between adjacent panes of a window or between adjacent windows in a tandem pair. The interstitial surface is enclosed, and is thereby protected from disruption of the air layer by wind or external air flow.
light. In the context of this patent application, electromagnetic radiation that passes through, or is intercepted by, or is modified by, a window assembly. Light includes visible light, ultraviolet light, infrared light, and heat radiation of all wavelengths.
molding. In the context of this patent application, a covering that surrounds the frame of a window or that covers the window frame, either completely or partially.
moisture. In the context of this patent application, water vapor that is contained in the air surrounding and inside a window assembly. The moisture may be entirely in the gaseous state, or it may be partially condensed into liquid water upon surfaces.
pane. An individual sheet of glazing material that is a component of a window.
R-value. A standard measure of the resistance of any material to conductive heat flow. It is the inverse of the thermal conductivity of the material.
sash. A portion of a window assembly that consists of one or more panes that are held within a frame. In a window having fixed glazing, a sash may comprise the entire window. In a window that is openable, the openable component is a sash that is a sub-assembly of the window that is held within the frame of the complete window.
static pressure. The pressure of air or other gases that is independent of the velocity of the gas. An example is the pressure of air inside a balloon.
storm window. In prior art, an inexpensive, lightweight form of glazing that is installed to supplement a conventional window. Generally deficient in longevity, thermal properties, resistance to air leakage, venting, and convenience.
tandem. In the context of this patent application, an arrangement of two separate windows within a window opening, in which one window is placed outside the other, so that light passes through both windows in sequence.
thermal conductivity. A measure of the heat flow through a material, expressed as heat flow (in units of energy per unit of time) per unit of surface area of the material per degree of temperature difference across the material.
thermal resistance. The resistance of a material or an entity to heat flow. Commonly quantified as R-value.
velocity pressure. The pressure exerted by air or other gases in motion that results when the gas is halted, slowed, or changed in direction. An example is the pressure exerted by wind on the outside wall of a building.
window. In the context of this invention, a component that is inserted into the wall of a building or other enclosed space that is intended to allow light to pass through the wall while blocking the passage of air and minimizing the loss of heat.
window treatment. A term that encompasses various accessories for windows. Such accessories may have the purpose of providing privacy, blocking sunlight, providing decoration, or other purposes.

### DESCRIPTION OF THE DRAWING

FIG. 1 shows a representative embodiment.

### DETAILED DESCRIPTION OF THE INVENTION

A primary principle of my invention is the installation of high-efficiency windows in tandem pairs, which is made practical primarily by improvements in the configuration of the frames of the windows.

The following is a representative embodiment. The embodiment comprises a method of installation, specific features of the frame configuration, improvements in venting to avoid condensation on the panes, and a feature to prevent condensation on the inner frame of the inner window.

In this embodiment, an increase in separation between the pair of windows is achieved primarily by configuring the frame of the inner window so that it can be attached to the inner wall surfaces of the window opening in a manner that extends the body of the inner window inward. The frame of the outer window may be configured similarly to extend the body of the outer window outward.

The term “inner window” refers to the window that is mounted toward the inside of the enclosed space. The term “outer window” refers to the window that is mounted toward the outside of the enclosed space.

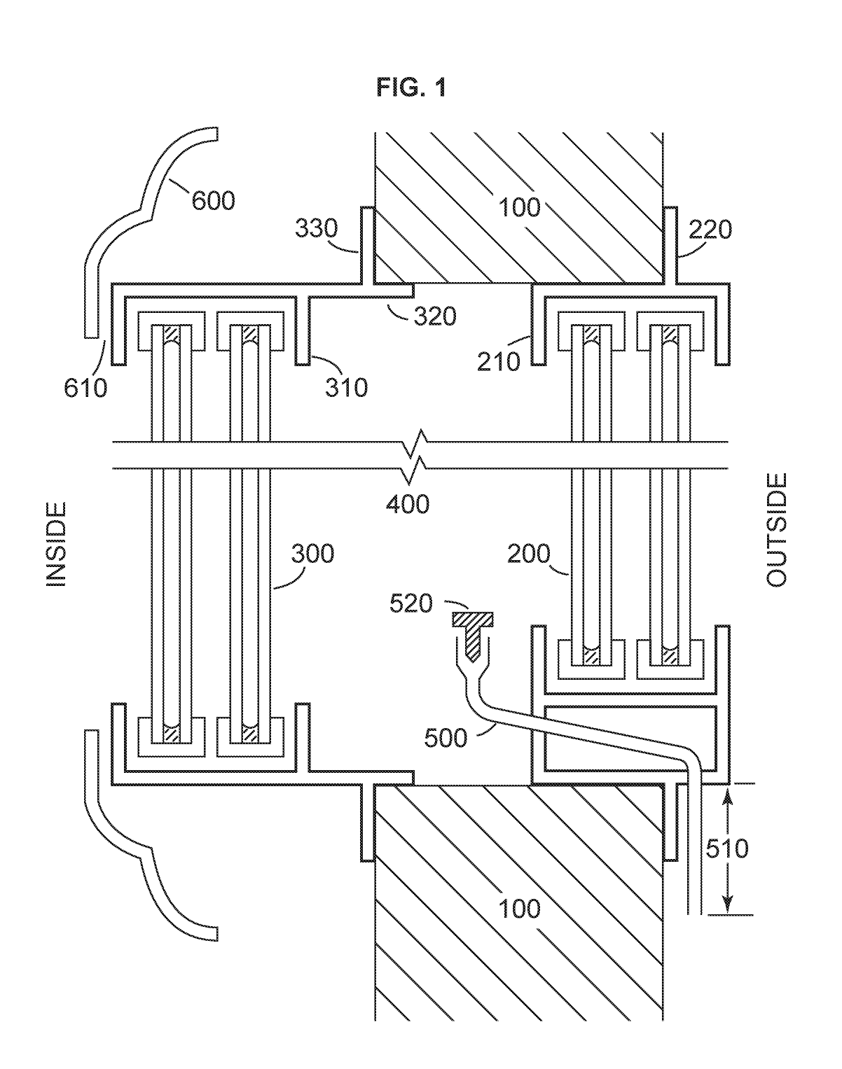

FIG. 1 shows the elements of the embodiment as follows:
a window opening in wall 100
an openable outer window 200, having a conventional arrangement for opening the window for ventilation, comprising one fixed sash with double panes and one horizontally sliding sash with double panes
a frame 210 for window 200
a flange 220 that surrounds frame 210 and is an integral part of frame 210, that provides for attachment of the outer window 200 to the outer surface of wall 100
an openable inner window 300, having a conventional arrangement for opening the window for ventilation, comprising one fixed sash with double panes and one horizontally sliding sash with double panes
a frame 310 for window 300
a novel extension 320 of frame 310 that extends the body of window 300 inward
a flange 330 that is part of the novel frame extension 320, which provides for attachment of the inner window 300 to the inner surface of wall 100
an interstitial space 400 between window 200 and window 300, which is wide enough to allow convenient opening and closing of the outer window from inside the space, to allow convenient operation of any latching and locking devices on the outer window from inside the space, and to allow convenient cleaning of all the surfaces facing into interstitial space 400
the frame 210 of window 200 being configured to project the window toward the outside, and the frame 310 of window 300 being configured to project the window toward the inside, to provide the desired width of interstitial space 400
a vent tube 500 that is incorporated into the bottom of the frame 210 of outer window 200, comprising a path for venting water vapor from interstitial space 400 to the outside
the vent tube 500 being sloped continuously downward toward the outside
the vent tube 500 being sealed to frame 210 to prevent any leakage of air around the outside of vent tube 500
the vent tube 500 being extended downward on the outside by the distance 510 between the bottom of interstitial space 400 and the bottom of vent tube 500, and the volume of the lower portion of vent tube 500 being great enough, to prevent entry of outside air into space 400 as a result of temperature changes, atmospheric pressure changes, and wind pressure
the bottom opening of vent tube 500 being horizontal to minimize the velocity pressure of wind within the vent tube
a plug 520 that may be inserted or removed at the end of vent tube 500 that is located within interstitial space 400
a cover 600 over the inner portion of frame 310 of the inner window 300, that provides decoration, protects the inner portion of the frame 310 of the inner window, and protects against impact with the sharp inward facing portions of frame 310
a continuous vent space 610 that separates the cover 600 from the window frame 310 and from the interior surfaces of wall 100, which allows air in the interior space to circulate between the cover 600, the frame 310, and the adjacent surfaces of wall 100, warming the frame and adjacent wall surfaces, thereby inhibiting the condensation of moisture on the frame, and allowing any moisture that may condense on the window frame to evaporate freely into the interior space.

For brevity in describing the inventions, it is assumed that the interior of the space is warmer than the outside, so that the inner window is warmer than the outer window. However, my invention applies equally when the outside is warmer than the inside, as for example, with a refrigerated enclosure. In the latter case, the venting of moisture from the interstitial space between the inner and outer windows is directed toward the interior of the enclosure.

The materials and manufacturing methods of the windows are well known to the window manufacturing industry and to those with ordinary skill in the related arts.

### Frame Configuration to Increase Separation Between the Inner and Outer Windows

My invention makes it practical and convenient to compound the desirable characteristics of contemporary window technology (such as multiple panes, hermetic seals between panes, and insulating gases between panes), especially for energy efficiency. For example, if installation of individual windows is constrained by a weight limit, two windows of that weight can be installed independently of each other within the window opening. Thereby, it becomes practical for the R-value of the paired window assembly to be more than double the R-value that is achievable by a single window.

The modification of the frame of the inner window makes it practical and convenient to mount a high-efficiency window on the inside of the window opening in a manner that is fully compatible with the installation of a high-efficiency window on the outside of the window opening.

Another efficiency benefit of my invention is that by maximizing the separation between the inner and outer windows, the path that escaping heat must travel through the surrounding structure of the window opening is lengthened, reducing the heat loss.

For pairs of tandem windows that are openable, the enhanced separation between the inner and outer windows that is provided by the invention allows:
convenient opening of the inner and outer windows together,
convenient operation of the latching and locking devices of the inner and outer windows
convenient access to the surfaces in the interstitial space between the windows for cleaning.

In prior art, in the case of high-efficiency windows with flanged frames, the window is mounted on the outside in order to exploit the rain shedding capability of the flanged design. In the case of window frames without flanges, a high-efficiency window must be installed somewhere within the width of the wall opening so that it can be held in place by stops that are attached to the inner structure of the window opening. The typical thickness of contemporary walls forestalls the possibility of installing two high-efficiency windows within the same wall opening, especially in a manner that allows convenient operation and cleaning of both windows.

### Improved Venting to Prevent Condensation in the Interstitial Space

The embodiment of FIG. 1 illustrates several improvements to venting of the interstitial space 400 between the inner and outer windows of the tandem pair.

In this embodiment, the vent path is a tube that passes through the frame structure, as illustrated by vent tube 500 in FIG. 1.

This embodiment minimizes the infiltration of outside air through the vent tube by locating the outer opening of the vent tube below the level of the bottom of the interstitial space by a distance that is sufficient to prevent convective entry of outside air into the interstitial space, and to prevent the forcing of outside air into the interstitial space by wind pressure. Extension of the exit (outer) end of the vent tube below the level of the bottom of the interstitial space is illustrated by the distance 510 in FIG. 1.

The volume of the external portion of the vent tube 500 is determined by the change in the volume of the air within the interstitial space 400 that may result from changes in temperature, atmospheric pressure, and wind, which induce flow of outside air through the vent tube. The length and volume of the vent tube are great enough so that outside air cannot flow all the way from the exterior opening of the vent tube to the interior portion of the vent tube.

The open outer end of the vent tube is shielded from the velocity pressure of wind by facing the exterior opening of the vent tube downward.

Generally, a moisture vent for the interstitial space is unnecessary if the air leakage rate of the inner window is sufficiently less than the air leakage rate of the outer window so that condensation within the interstitial space cannot occur. In such circumstances, the vent may be closed, eliminating any efficiency loss resulting from the use of a moisture vent. In this embodiment, the capability of closing the vent tube is provided by a plug 520, as illustrated in FIG. 1.

### Vented Cover of the Interior Frame

The frame of an inner window that protrudes into the interior space may create an unusual appearance, and it may pose a risk of impact on sharp corners of the frame. To avoid these problems, a cover or molding may be installed around the protruding portion of the inner frame.

However, a frame cover may cause condensation on the frame and adjacent wall surfaces if the cover is installed directly over the frame material. In such a case, the cover would act as insulation that would keep the frame cooler than it would be if it were exposed to the indoor space temperature. If water vapor in the air on the warm side of the window can penetrate past the molding to the window frame, it may condense there and accumulate. Persistent moisture promotes the formation of mildew, deterioration of surrounding structural or trim materials, and corrosion of any vulnerable metals.

This embodiment introduces a solution to this potential problem by using a cover over the interior surface of the frame that is vented all around the frame. The venting allows free convective circulation of indoor air between the cover, the window frame, and the adjacent wall surfaces. The air circulation warms the inner frame surface, thereby reducing the tendency to condensation, and it allows free evaporation of any condensation that may occur. This embodiment of the vented cover is illustrated by cover 600 and cover vent space 610 in FIG. 1.

### Independence of Window Installation

The inner and the outer windows may be installed independently of each other, so that the combination does not increase the difficulty of installation.

The pair of windows may be installed at one time, or an inner or an outer window may be installed on a retrofit basis to form a compatible pair with the originally installed window.

In a retrofit installation, the novel extension of the frame allows the window that is installed later to have virtually any characteristics that are compatible with the originally installed window.

### Further Embodiments

Further embodiments are possible, including but not limited to the following:
The vent path from the interstitial space to the outside can be installed independently of either window. For example, a vent tube similar to vent 500 in FIG. 1 is embedded in a slot that is located in the bottom of the window opening before installation of the outer window.
The opening of the vent path may be made adjustable, for example, by using a needle valve in the vent path. In window pairs that are openable, the valve may be installed either inside the space between the windows or in the exit side of the vent. In windows that are not openable, the valve may be installed on the exit side of the vent.
Moisture may be vented from the interstitial space using a hollow channel within the frame, separate from the rest of the frame, that has one or more openings to collect water vapor from the space between the two windows, and that discharges the water vapor to the outside through a conduit that extends below the bottom of the interstitial space.
The vented cover for the frame of the inner window may be used to attach window treatments, for example, curtains and blinds.

1-33. (canceled)

34. A tandem window assembly for installation in a window opening in a wall, having an interior portion and an exterior portion and a thickness therebetween, comprising:
an inner primary window assembly and a separate outer primary window assembly each installed independently of one another on respective interior and exterior portions of said window opening in said wall, said window assemblies, when installed in said window opening, defining an interstitial space between said respective separate window assemblies and surrounded by said window opening in said wall, said interstitial space being of a predetermined depth set by an installer to enable separate operation of said respective windows.

35. A tandem window assembly as in claim 34, further comprising:
an extended element mounted with and supporting said inner window assembly along a perimeter of a frame of said inner window assembly, said extended element extending and protruding said inner window assembly toward and into an interior space with respect to said interior surface of said wall so that said interstitial space predetermined depth can exceed said thickness.

36. A tandem window assembly as in claim 35, further comprising:
a cover placed around said protruding inner window assembly frame, said cover being spaced from said inner window assembly frame to allow interior air to circulate between said frame and cover and allow for any moisture accumulating on said inner window assembly frame to be removed via said circulating air.

37. A tandem window assembly as in claim 34, further comprising:
a vent extending from within said interstitial space downwardly and exteriorly with respect to said interstitial space, said vent including an exterior end facing downwards and positioned below said interstitial space, said tube forming a chamber therein of sufficient size and length to prevent ingress of exterior air into said interstitial space.

38. A tandem window assembly as in claim 34, further comprising
a vent extending from within said interstitial space having a removeable plug for insertion into said vent so as to reversibly control the ingress and egress of air from said interstitial space.

39. A method of installing tandem windows in a window opening in a wall to improve the energy efficiency of the window installation, comprising the steps of:
installing a first primary outer window assembly to an outer portion of said window opening,
selecting a desired separation for installation of a second primary inner window and, thereafter, installing a second separate primary inner window assembly to a second interior portion of said window opening,
thereby defining, between said installed windows, an interstitial space of said desired separation that is surrounded by the frames of said primary widows and by said window opening, said interstitial space enabling separate operation of said respective window assemblies, providing access for cleaning, and for other purposes.

40. A method as in claim 39, further comprising:
adding an extended element mounted with and supporting said inner window assembly along a perimeter of a frame of said inner window assembly, said extended element extending and protruding said inner window assembly inward into an interior space with respect to said interior surface, and providing any desired separation between the said inner primary window assembly and the said outer primary window assembly

41. A method as in claim 40, further comprising:
installing a cover surrounding and onto, and in spaced relation to, a perimeter of said inner window assembly protruding into an interior space before said wall, so as to permit air to circulate between said perimeter and said cover and remove moisture from inner surfaces of said first window assembly.

42. A method as in claim 39, further comprising:
providing a vent extending into said interstitial space, said vent extending downwardly and exteriorly with respect to said interstitial space, and said vent having an outer end thereof facing downwardly and being positioned below said interstitial space, said vent forming a chamber therein of sufficient size and length to prevent ingress of exterior air into said interstitial space caused by wind, change of air pressure, or change in temperature.

43. A method as in claim 39, further comprising:
a vent extending from within said interstitial space having a removeable plug for insertion into said vent so as to reversibly control the ingress and egress of air from said interstitial space.
